(19) United States
(12) Patent Application Publication
(10) Pub. No.: US 2014/0317506 A1
(43) Pub. Date: Oct. 23, 2014

(54) MULTIMEDIA EDITOR SYSTEMS AND METHODS BASED ON MULTIDIMENSIONAL CUES

(71) Applicant: WEVIDEO, INC., Mountain View, CA (US)

(72) Inventors: Bjørn Rustberggaard, Nesoya (NO); Krishna Menon, Saratoga, CA (US); Jens Pettersen, Oslo (NO)

(73) Assignee: WEVIDEO, INC., Mountain View, CA (US)

(21) Appl. No.: 14/181,455

(22) Filed: Feb. 14, 2014

Related U.S. Application Data
(60) Provisional application No. 61/815,207, filed on Apr. 23, 2013.

(51) Int. Cl. G06F 3/0484

(52) U.S. Cl. CPC G06F 3/0484
USPC 715/716

(57) ABSTRACT

According to certain implementations, systems and methods can access foundational content a user intends to enhance with an effect, the foundational content having an associated timeline that defines a temporal property with respect to the foundational content; apply the effect to the foundational content; and adapt application of the effect according to a multidimensional cue that is configured to trigger an action with respect to the effect, at a temporal position on the timeline when a condition with respect to the context of the foundational content is satisfied.

This application claims priority to U.S. Provisional Patent Application No. 61/815,207, filed Apr. 23, 2013, entitled “MULTIMEDIA EDITOR SYSTEMS AND METHODS BASED ON MULTIDIMENSIONAL CUES,” which is incorporated herein by reference.

### BACKGROUND

With conventional editing equipment, creative professionals use physical media to capture specific scenes and manually add soundtracks, video clips, and special effects to incorporate creative elements like story elements, plots, characters, and thematic elements. The process provides a classical touch and feel that aligns with the creative energies of film producers, directors, screenwriters, and editors. However, the process can be expensive, time-consuming and complicated, sometimes requiring access to editing equipment typically located in film studios.

Locally installed film editing systems, such as standalone computer programs, allow users to edit digital multimedia using locally stored special effects, including those relating to pre-defined themes. Pre-defined themes usually include a set of special effects that correspond to the theme and that permit a user, particularly a novice user, to simply and easily enhance their multimedia content. However, locally installed film editing systems require users to purchase special effects packages, limiting a user to the editing effects and pre-defined themes locally installed on his or her computer. Further, the pre-defined themes often include static audio or visual effects, and do not provide users with flexibility to adapt application/behavior of effects (e.g., theme-based effects) to their liking.

The foregoing examples of film editing systems are intended to be illustrative and not exclusive. Other limitations of the art will become apparent to those of skill in the relevant art upon a reading of the specification and a study of the drawings.

### SUMMARY

The present application discloses systems and methods of creating or modifying content (e.g., video or audio content) using multidimensional cues. In particular, various implementations apply an audio or visual effect to content in accordance with one or more multidimensional cues. A given multidimensional cue can determine application of an effect to content based on: (1) a temporal property and/or a non-temporal property of the content to which the effect is being applied; and/or (2) a temporal property and/or a non-temporal property of another effect applied to the content.

As used herein, “foundational content” refers to multi-media content (e.g., movies, audio, animations, presentations, etc.) that a user intends to enhance using one or more effects. When a given effect is applied to foundational content, it can modify and/or augment audio or visual aspects of the foundational content in accordance with the effect. Where the foundational content comprises two or more layers of content (i.e., multi-layered), an effect can modify and/or augment one, some, or all of the layers of the foundational content. In some implementations, the effect can be applied to the foundational content by being expressed in a one or more effect layers (e.g., audio or video layers) disposed over one or more layers of the foundational content. Additionally, once an effect is applied to foundational content, it can be configured to be expressed for the entire duration of the foundational content or expressed at one or more time intervals during the duration of the foundational content.

For a given effect, one or more associated parameters (hereafter, “effect parameters”) can determine the expression of the effect with respect to the foundational content. For example, during expression of a given effect, an associated effect parameter can determine how long the given effect is expressed, where on the foundational content the given effect is expressed (e.g., position of the given effect), content of the given effect (e.g., where the given effect is text-based), movement of the given effect (e.g., path of movement for the given effect), rate of an effect (e.g., playback speed of the given effect where the given effect is an animation effect), level of an effect (e.g., volume level for the given effect where the audio effect, or color levels for the given effect where the given effect is a color correction effect), and the like. One or more effect parameters of a given effect can be adjusted during the duration of the foundational content. As such, an effect parameter for a given effect can vary during the duration of the foundational content, possibly according to one or more temporal indicators associated with a timeline relating to the foundational content (e.g., timeline relating to a layer of the foundational content). Depending on the implementation, effect parameters can be defined by numeric values or alphanumeric strings that determine the behavior/impact of the effect.

In some implementations, the effects applied can are according to a theme. As used herein, a “theme” can comprise one or more layers of theme-based effects, which may be audio or visual in nature and facilitate the overall effect of the theme on the content being created or modified. A given theme can include one or more audio or visual effects relating to the given theme (i.e., theme-based effects). Accordingly, a theme can include a set of theme-based effects that upon application to content, can cause at least a portion of content to be stylized in accordance with aspects of the theme. In doing so, a theme once applied to content can augment the content with thematic elements that impart a theme-related look, feel, or tone to one or more portions of content. For various implementations, the theme can augment the content while preserving the underlying content being presented.

Example of theme layers can include soundtrack layers, sound effect layers, animated visual layers, static visual layers, color adjustment layers, and filter layers. Example of theme-based effects included in the theme can include visual overlays (e.g., animated or static images/graphics), text-based overlays (e.g., captions, titles, and lower thirds), transitions (e.g., visual or audio transitions between content portions), audio overlays (e.g., soundtracks and sound effects), and the like. Example of themes can include those relating to fashion (e.g., fashionista theme), traveling (e.g., journeys or vacations), time eras (e.g., vintage theme or disco theme), events (e.g., party-related themes), genres of book, music or movies (e.g., punk rock music or black noir movies), and the like. Particular implementations can provide separation between editing processes associated with content the user intends to enhance using the theme (e.g. sequence of content portions and content transitions), and audio/visual styling processes of theme that enhance the underlying content. Hereafter, content that a user intends to enhance using effects, particularly theme-based effects, are referred to as “foundational content.”

As used herein, a “cue” can include a temporal indicator associated with a timeline and configured to trigger, at a specific time (e.g., temporal position) on the timeline, an action with respect to an audio or visual effect (hereafter, a “target effect”) and foundational content. For example, at a specific time position on a timeline, a cue can trigger an action with respect to a target effect that is currently applied to the foundational content and that is either enabled or disabled (e.g., expressed or not expressed) at the specific time position. An example of the latter could include where a cue, at a given time position on a timeline, triggers the expression (e.g., enables) of a visual effect that is not expressed (e.g., that is disabled) at the given time position. An example of the former could include where a cue, at a given time position on a timeline, triggers a change in the behavior/impact of a visual effect currently being expressed over the foundational content (e.g., currently enabled) at the given time position. The change in behavior/impact can be facilitated by a change in an effect parameter of that visual effect. Actions triggered with respect to effects can include, without limitation, enabling or disabling expression of effects, initiating a transitional start or end of effects (e.g., fading-in start or fade-out end for an effect), implementing transitions between two or more effects, defining effect parameters, adapting effect parameters of effects, and the like. Where a theme is applied to foundational content, a cue can trigger actions with respect to one or more theme-based effects that convey the overall effect of the theme on the foundational content.

A used herein, a “multidimensional cue” can be an indicator that triggers an action, with respect to a target effect, based on one or more factors relating to the context to which the target effect is being applied (hereafter, referred to as “contextual factors”), where the contextual factors include more than just time-related factors (e.g., more than just a temporal position on a timeline associated with the foundational content). In particular, a given multidimensional cue can define one or more conditions relating to contextual factors and trigger an action with respect to a target effect when the conditions are satisfied. Depending on the implementation, the context to which a target effect is being applied can be defined by the foundational content to which the target effect is being applied and/or one or more other effects being applied to the foundational content. An example of a multidimensional cue can include one that triggers an action with respect to a target action when conditions relating to one or more temporal factors of the context and one or more non-temporal factors of the context are satisfied (i.e., when one or more temporal contextual factors and one or more non-temporal contextual factors meet conditions defined by the multidimensional cue). Another example of a multidimensional cue can include one that triggers an action with respect to a target action only when conditions only relating to one or more non-temporal contextual factors (i.e., no temporal contextual factors) are satisfied.

A temporal contextual factor can include a temporal position on a timeline that is associated with the foundational content and/or an effect applied to the foundational content. For some implementations, a multidimensional cue can trigger an action with respect to a target effect at or after a specific time position on a timeline and when a condition relating to a non-temporal contextual factor is satisfied.

A non-temporal context factor can include attributes of the target effect applied to the foundational content (e.g., type of the effect or parameter of the target effect), attributes of one or more other effects applied to the foundational content (e.g., types of effects or parameters of the target effect), and attributes of the foundational content (e.g., content type or other characteristics of the foundational content). Examples of non-temporal context factors include the expression of one or more effects applied to the foundational content (e.g., at the time of the multidimensional cue), volume level of audio provided by one or more other effects applied to the foundational content, volume level of audio provided by of the foundational content, frequency level of audio provided by one or more other effects applied to the foundational content, frequency level of audio provided by the foundational content, color level of one or more other effects applied to the foundational content, color level of the foundational content, movement or rate of movement of objects in the foundational content (e.g., based on pixels), and the like. It should be understood that various audio-related and visual-related attributes can be used as non-temporal context factors. For some implementations, information regarding non-temporal contextual factors can be obtained from metadata associated with effects and/or metadata associated with foundational content.

As discussed herein, actions triggered by a multidimensional cue can include, for example, enabling or disabling expression of effects, enabling a transitional start or end of effects (e.g., fading the effect in or out), implementing transitions between two or more effects, defining effect parameters, adapting effect parameters, and the like.

According to certain implementations, systems and methods can access foundational content a user intends to enhance with an effect, the foundational content having an associated timeline that defines a temporal property with respect to the foundational content; apply the effect to the foundational content; and adapt application of the effect according to a multidimensional cue that is configured to trigger an action with respect to the effect, at a temporal position on the timeline when a condition with respect to the context of the foundational content is satisfied. Implementations can create the multidimensional cue before or after the application of the effect to the foundational content. The context of the foundational content can include an audio attribute or visual attribute of the foundational content (e.g., soundtrack or video output of the foundational content). When an implementation applies another effect to the foundational content, the context of the foundational content can include an audio attribute or visual attribute of the foundational content as that attribute is modified by the other effect. For some implementations, performance of the action with respect to the effect can depend if and only if a first condition is satisfied regarding the content of the foundational content and a second condition is satisfied regarding a temporal position on the timeline associated with the foundational content (e.g., when the current temporal position of the foundational content is at or beyond the temporal position defined by the second condition).

As noted above, the action performed with respect to the foundational content can include: enabling or disabling the expression of the effect; and adjusting a parameter of the effect, and the parameter determines how the effect is expressed with respect to the foundational content. The parameter can define how expression of the effect begins or ends, a position of the effect, or a movement of the effect. Depending on the implementation, the effect that is applied can be part of a theme that is being applied to the foundational content.

### BRIEF DESCRIPTION OF THE DRAWINGS

FIG. 1 depicts a diagram of an example of a system for multidimensional cue-based content editing in accordance with various implementations.

FIG. 2 depicts a diagram of an example of a system for multidimensional cue-based content editing in accordance with some implementations.

FIG. 3 depicts a diagram illustrating an example adaptation of a timeline in accordance with some implementations.

FIG. 4 depicts a diagram illustrating an example structure of a theme-based foundational content in accordance with some implementations.

FIG. 5 depicts a flowchart of an example of a method for multidimensional cue-based content editing in accordance with some implementations.

FIG. 6 depicts a diagram of an example of a client-side user interface for multidimensional cue-based content editing in accordance with some implementations.

FIG. 7 depicts a diagram of an example of an interface for selecting a theme for application in accordance with some implementations.

FIG. 8 depicts a diagram of an example of a system on which techniques described herein can be implemented.

### DETAILED DESCRIPTION

This paper describes techniques that those of skill in the art can implement in numerous ways. For instance, those of skill in the art can implement the techniques described herein using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used herein, the term ‘processor’ refers to one or more devices, circuits, and/or processing cores configured to process data, such as computer program instructions.

These details are provided for the purpose of example and the invention may be practiced according to the claims without some or all of these specific details. For the purpose of clarity, technical material that is known in the technical fields related to the invention has not been described in detail so that the invention is not unnecessarily obscured. However, numerous specific details are set forth in the following description in order to provide a thorough understanding of the invention.

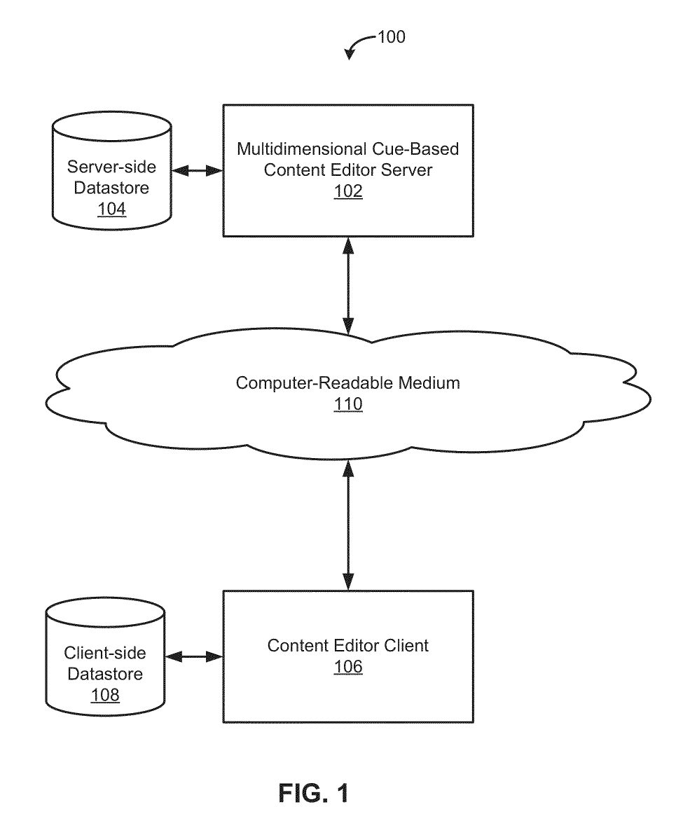

FIG. 1 depicts a diagram 100 of an example of a system for multidimensional cue-based content editing in accordance with various implementations. In the example of FIG. 1, the system includes a multidimensional cue-based content editor server 102, a server-side datastore 104 coupled to the multidimensional cue-based content editor server 102, a content editor client 106, a client-side datastore 108 coupled to the content editor client 106, and a computer-readable medium 110 coupled between the multidimensional cue-based content editor server 102 and the content editor client 106.

As used in this paper, the term “computer-readable medium” is intended to include only physical media, such as a network, memory or a computer bus. Accordingly, in some implementations, the computer-readable medium can permit two or more computer-based components to communicate with each other. For example, as shown in FIG. 1, the computer-readable medium 110 can be a network, which can couple together the multidimensional cue-based content editor server 102 and the content editor client 106. Accordingly, for some implementations, the computer-readable medium 110 can facilitate data communication between the multidimensional cue-based content editor server 102 and the content editor client 106.

As a network, the computer-readable medium 110 can be practically any type of communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). For example, the computer-readable medium 110 can include one or more wide area networks (WANs), metropolitan area networks (MANs), campus area networks (CANs), or local area networks (LANs); theoretically, the computer-readable medium 110 could be a network of any size or characterized in some other fashion. Networks can include enterprise private networks and virtual private networks (collectively, “private networks”). As the name suggests, private networks are under the control of a single entity. Private networks can include a head office and optional regional offices (collectively, “offices”). Many offices enable remote users to connect to the private network offices via some other network, such as the Internet. The example of FIG. 1 is intended to illustrate a computer-readable medium 110 that may or may not include more than one private network.

As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

In some embodiments, the content editor client 106 can leverage the computing resources and power of the multidimensional cue-based content editor server 102 when creating or modifying elements of foundational content, especially using an effect in accordance with a multidimensional cue. In some instances, the effect can be part of a theme comprising one or more theme-based effects. Often, the multidimensional cue-based content editor server 102 comprises computing resources that surpass those of the content editor client 106, that are better suited for content editing based on multidimensional cues, or that are better suited for content creation or modification than those of the content editor client 106. Though FIG. 1 depicts a single content editor client, the system can include multiple content editor clients that can communicate with the multidimensional cue-based content editor server 102.

Foundational content includes multimedia-based content, whether audio, visual, or audio-visual, that a user enhances using a theme as described in this paper. The multimedia-based content may be authored or otherwise produced by a user using the content creation/editing tool. Foundational content can include content initially based on/started from a vendor-provided or user-provided content. For example, user-provide content used as foundational content can be sourced from a user's personal datastore, such as a memory device coupled to the user's personal computer or integrated in the user's smartphone or camera. Examples of user-provided content (possibly sourced from a personal datastore) can include video recordings of such personal events as weddings, birthday parties, anniversary parties, family vacations, graduations, and those relating to family events (e.g., a child's first steps, a family picnic, a child's recital). In some instances, the foundational content is generated, by a user, using a selection of content segments sourced from user-provided content and/or vendor-provide content. Accordingly, the foundational content can comprise a composition of content portion originating from multiple sources. Accordingly, an example foundational content can comprise a sequence of video clips provided by a user. The foundational content may or may not be one composed by the user to tell a particular story, often one relating to a particular event or occasion (e.g., tells of a personal accomplishment or journey).

The foundational content can be created to be multi-layered content, comprising multiple content layers of different content types include, for example, audio, video, still images/graphics, animation, transition, or other content generated by a content generator. A content generator is typically an individual, but can also be a group, a business entity, or other entity, that creates content using a device like a camera, a video camera, an electronic device (such as a mobile phone or other electronic device), or other device. In some embodiments, the content generator's device can comprise an electronic scanner used to capture a painting or drawing. The content generator's device can also include an electronic device that captures content using an input device (e.g., a computer that captures a user's gestures with a mouse or touch screen). High definition/quality content as used herein includes content having definition or quality that is higher than the average definition or quality for the similar content. For example, high definition/quality audio content can include audio clips having a high sampling rate (e.g., 44 KHz), has a higher bit-rate or effective bit-rate (e.g., 256 Kbs), or is encoded in a lossless audio encoding format.

A theme can comprise one or more layers of theme-based effects, which may be audio or visual in nature and facilitate the overall effect of the theme on the content being created or modified. In some embodiments, themes comprise a pre-defined set of theme-based effects that relate to the theme, and are available for use through the system of FIG. 1 for free or for based on a fee (e.g., fee per a theme, or fee-based subscription). The pre-defined themes may or may not be authored through the use of the system of FIG. 1, and may or may not be authored by a third-party (e.g., another user of the system of FIG. 1, or third-party service hired by the provider of the system of FIG. 1). In certain instances, a theme can augment or enhance the ability of a foundational content to tell a particular story, often one relating to a particular event or occasion (e.g., tells of a personal accomplishment or journey).

In a specific implementation, a user at the content editor client 106 to instruct the multidimensional cue-based content editor server 102 to apply an effect to the foundational content, to adapt application of an effect according to a multidimensional cue, and to possibly create or modify foundational content, on behalf of the client 106. As noted, the foundational content can be multi-layered content comprising a plurality of content layers, where each content layer comprises one or more content items from a content library, and the content items are provided by a third-party vendor or the user of the content editor client 106. After a user-selected effect is applied to the foundational content, the application of the effect can be adapted by actions defined by the multidimensional cue for a temporal position on a timeline associated with the foundational content. For instance, the associated timeline can be the timeline of the foundational content or some other timeline associated with the foundational content (e.g., timeline separately maintained for the effect with respect to the foundational content). In accordance with some implementations, the action defined by the multidimensional cue can be triggered when a condition relating to the context of the foundational content is satisfied. The context of the foundational content can include various characteristics relating to the foundational content, such as audio levels, audio frequency, pixel changes, color level, movement of objects, rate of movement of objects, and the like. For some implementations, the effect being applied to the foundational content can be part of a theme selected for application to the foundational content.

Following the application of one or more effects in accordance with actions defined by a multidimensional cue, the resulting foundational content can be rendered to a rendered content product, which is be ready for consumption by others. In some implementations, consumption (e.g., playback) of the resulting foundational content may or may not be limited to the system of FIG. 1, whereas the rendered content product is consumable by stand-alone media players external to the system of FIG. 1.

To facilitate theme application and/or modification of the foundational content, the multidimensional cue-based content editor server 102 can prepare a copy of a latest version of the foundational content for the content editor client 106 to preview, to apply an effect and/or modify content elements, possibly in accordance with a multidimensional cue. Once prepared by the multidimensional cue-based content editor server 102, the copy of the latest version of the foundational content can be maintained by and stored at the multidimensional cue-based content editor server 102 (e.g., on the server-side datastore 104) on behalf of the content editor client 106. Then, when the content editor client 106, for example, desires to apply an effect or a modification to the latest version of the foundational content, in accordance with a multidimensional cue, it does so using the copy of the latest version of the foundational content.

In some implementations where the copy of the latest version of the foundational content is maintained at the server 102 (e.g., on the server-side datastore 104), the client 106 can instruct the server 102 to perform the desired effect applications and/or modifications to the copy of the latest version of the foundational content, in accordance with a multidimensional cue. Subsequently, the client 106 can instruct the server 102 to provide the copy of the resulting foundational content to the client 106. In some implementations where the copy of the latest version of the foundational content for the content editor client 106 is maintained at the client 106 (e.g., on the client-side datastore 108), the client 106 can directly modify the copy of the latest version of the foundational content, in accordance with a multidimensional cue, and, subsequently, send the modifications applied to the copy of the latest version of the foundational content to the server 102 (which can update the latest version of the foundational content with the received modification).

With respect to some implementations, the application of an effect or modification to the foundational content by the content editor client 106 can include, in addition to content modification operations performed in accordance with a multidimensional cue, such operations as: adjusting copyright use limitations on some or all of the foundational content, locking some or all portions of the foundational content such that some or all of the foundational content is prevented from being modified, adding watermarks to some or all of the foundational content, or tagging objects (e.g., people, places, or things) shown in the foundational content.

As the multidimensional cue-based content editor server 102 applies effects, or creates/modifies the foundational content product in accordance with a multidimensional cue, the server 102 can provide the content editor client 106 with an updated version of the foundational content product. The content editor client 106 can use the resulting foundational content product (which may or may not comprise proxy content items) for review or editing purposes as the client 106 continues to apply themes or modify the foundational content.

As the multidimensional cue-based content editor server 102 applies effects, or creates/modifies the foundational content product in accordance with a multidimensional cue (e.g., based on instructions received from content editor client 106), the server 102 can store one or more versions of the foundational content on the server-side datastore 104. When the content editor client 106 receives a new or updated version of the foundational content, the client 106 can store these on the client-side datastore 108 before the client 106 directly applies an effect or modifies the new/updated foundational content.

When a theme application, content modification, or content update is transferred between the multidimensional cue-based content editor server 102 and the content editor client 106, such application, modification or update can comprise a list of modification instructions (e.g., including layer identification information, timeline information, content identification information, or information relating to multidimensional cues), a list of newly-created or modified multidimensional cues, a copy of the modified content in its entirety, or a copy of the content portions that are modified/updated.

In the example of FIG. 1, the multidimensional cue-based content editor server 102 and/or the content editor client 106 can include an operating system. An operating system is a set of programs that manage computer hardware resources, and provides common services for application software. The operating system enables an application to run on a computer, whereas only applications that are self-booting can generally run on a computer that does not have an operating system. Operating systems are found in almost any device that includes a computer (e.g., cellular phones, video game consoles, web servers, etc.). Examples of popular modern operating systems are Linux, Android®, iOS®, Mac OS X®, and Microsoft Windows®. Embedded operating systems are designed to operate on small machines like PDAs with less autonomy (Windows® CE and Minix 3 are some examples of embedded operating systems). Operating systems can be distributed, which makes a group of independent computers act in some respects like a single computer. Operating systems often include a kernel, which controls low-level processes that most users cannot see (e.g., how memory is read and written, the order in which processes are executed, how information is received and sent by I/O devices, and devices how to interpret information received from networks). Operating systems often include a user interface that interacts with a user directly to enable control and use of programs. The user interface can be graphical with icons and a desktop or textual with a command line. Application programming interfaces (APIs) provide services and code libraries. Which features are considered part of the operating system is defined differently in various operating systems, but all of the components are treated as part of the operating system in this paper for illustrative convenience.

In the example of FIG. 1, the multidimensional cue-based content editor server 102 and/or the content editor client 106 can include one or more datastores that hold content, effects, themes, multidimensional cues, timeline information, and/or other data. A datastore can be implemented, for example, as software embodied in a physical computer-readable medium on a general- or specific-purpose machine, in firmware, in hardware, in a combination thereof, or in an applicable known or convenient device or system. Datastores in this paper are intended to include any organization of data, including tables, comma-separated values (CSV) files, traditional databases (e.g., SQL), or other applicable known or convenient organizational formats. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure.

Various components described herein, such as those of the system of FIG. 1 (e.g., the multidimensional cue-based content editor server 102 or the content editor client 106) can include one or more engines, which can facilitate the application of themes to foundational content (thereby generating a theme-based foundational content). As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

In the example of FIG. 1, the multidimensional cue-based content editor server 102 and/or the content editor client 106 can include one or more computers, each of which can, in general, have an operating system and include datastores and engines. Accordingly, those skilled in the art will appreciate that in some implementations, the system of FIG. 1 can be implemented as software (e.g., a standalone application) operating on a single computer system, or can be implemented as software having various components (e.g., the multidimensional cue-based content editor server 102 and the content editor client 106) implemented on two or more separate computer systems.

In this example, the server 102 and the client 106 can execute multidimensional cue-based content editing services inside a host application (i.e., can execute a browser plug-in in a web browser). The browser plug-in can provide an interface such as a graphical user interface (GUI) for a user to access the content editing services on the multidimensional cue-based content editor server 102. The browser plug-in can include a GUI to display effects, themes, content and layers stored on the datastores of the multidimensional cue-based content editor server 102 and/or the content editor client 106. For instance, the browser plug-in can have display capabilities like the capabilities provided by proprietary commercially available plug-ins like Adobe® Flash Player, QuickTime®, and Microsoft® Silverlight®. The browser plug-in can also include an interface to execute functionalities on the engines in the multidimensional cue-based content editor server 102.

In the example of FIG. 1, the multidimensional cue-based content editor server 102 and/or the content editor client 106 can be compatible with a cloud-based computing system. As used in this paper, a cloud-based computing system is a system that provides computing resources, software, and/or information to client devices by maintaining centralized services and resources that the client devices can access over a communication interface, such as a network. The cloud-based computing system can involve a subscription for services or use a utility pricing model. Users can access the protocols of the cloud-based computing system through a web browser or other container application located on their client device.

In the example of FIG. 1, one or more of the engines in the multidimensional cue-based content editor server 102 and/or the content editor client 106 can include cloud-based engines. A cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices. In the example of FIG. 1, one or more of the datastores in the multidimensional cue-based content editor server 102 can be cloud-based datastores. A cloud-based datastore is a datastore compatible with a cloud-based computing system.

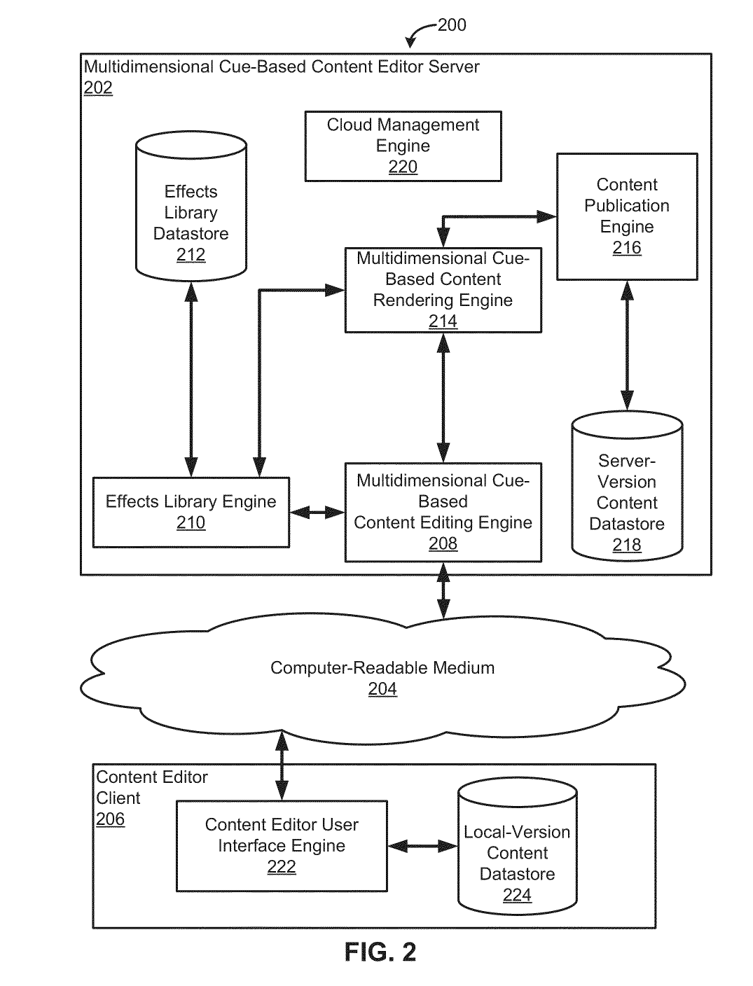

FIG. 2 depicts a diagram 200 of an example of a system for multidimensional cue-based content editing in accordance with some implementations. In the example of FIG. 2, the system includes a multidimensional cue-based content editor server 202, a content editor client 206, a computer-readable medium 204 coupled between the multidimensional cue-based content editor server 202 and the content editor client 206. For some implementations, the computer-readable medium 204 can be a network, which can facilitate data communication between the multidimensional cue-based content editor server 202 and the content editor client 206.

In the example of FIG. 2, the multidimensional cue-based content editor server 202 can include a multidimensional cue-based content editing engine 208, an effects library engine 210, an effects library datastore 212, a multidimensional cue-based effects content rendering engine 214, a content publication engine 216, a server-version content datastore 218, and a cloud management engine 220. The content editor client 206 can include a content editor user interface engine 222 and a local-version content datastore 224 coupled to the content editor user interface engine 222.

In the example of FIG. 2, the multidimensional cue-based content editing engine 208 can be coupled to the effects library engine 210, coupled to the multidimensional cue-based effects content rendering engine 214, and through the computer-readable medium 204, coupled to the content editor user interface engine 222. The effects library engine 210 can be coupled to the effects library datastore 212 and coupled to the multidimensional cue-based effects content rendering engine 214. The multidimensional cue-based effects content rendering engine 214 can be coupled to the multidimensional cue-based content editing engine 208, coupled to the effects library engine 210, and coupled to the content publication engine 216. The content publication engine 216 can be coupled to the server-version content datastore 218.

In the example of FIG. 2, the multidimensional cue-based content editing engine 208 can execute instructions regarding applying, in accordance with a multidimensional cue, effects to or modifying aspects of foundational content a user (e.g., at the content editor client 206) intends to enhance or modify. For some implementations, the multidimensional cue-based content editing engine 208 can apply effects and modify the foundational content using multidimensional cues by utilizing the functionality various engines included in the multidimensional cue-based content editor server 202, such as the effects library engine 210 and the multidimensional cue-based effects content rendering engine 214. In addition, for some implementations, the multidimensional cue-based content editing engine 208 can apply effects and modify the foundational content on behalf of, and in accordance with instructions received from, the content editor client 206.

As discussed herein, a given multidimensional cue can determine application of an effect to foundational content based on: (1) a temporal property and/or a non-temporal property of the foundational content to which the effect is being applied; and/or (2) a temporal property and/or a non-temporal property of another effect applied to the foundational content. In particular, a multidimensional cue can be an indicator that triggers an action, with respect to a target effect, based on one or more factors relating to contextual factors, which can include more than just time-related factors (e.g., more than just a temporal position on a timeline associated with the foundational content). A given multidimensional cue can define one or more conditions relating to contextual factors and trigger an action with respect to a target effect when the conditions are satisfied. Depending on the implementation, the context to which a target effect is being applied can be defined by the foundational content to which the target effect is being applied and/or one or more other effects being applied to the foundational content. An example of a multidimensional cue can include one that triggers an action with respect to a target action when conditions relating to one or more temporal factors of the context and one or more non-temporal factors of the context are satisfied (i.e., when one or more temporal contextual factors and one or more non-temporal contextual factors meet conditions defined by the multidimensional cue). Another example of a multidimensional cue can include one that triggers an action with respect to a target action only when conditions only relating to one or more non-temporal contextual factors (i.e., no temporal contextual factors) are satisfied.

For example, in certain implementations, the multidimensional cue-based content editing engine 208 can establish a data connection with the content editor client 206 through the computer-readable medium 204 (e.g., a network), can receive commands relating to effect application based on a multidimensional cue, content creation or content modification over the data connection (e.g., network connection), can perform effect application based on a multidimensional cue, content creation or content modification operations in accordance with commands received from the content editor client 206, and can transmit to the content editor client 206 a version of the foundational content that results from the operations (e.g., the resulting multidimensional cue-based foundational content). Depending on the implementation, the commands (relating to multidimensional cue-based effect application, content creation or content modification) may or may not be generated by the content editor user interface engine 222 residing at the content editor client 206. For some implementations, the content editor user interface engine 222 can generate commands as a user at the content editor client 206 interacts with a user interface presented by the content editor user interface engine 222.

During application of an effect based on a multidimensional cue, the multidimensional cue-based content editing engine 208 can adapt one or more timelines associated with the effect (herein, also referred to as “effect timelines”) relative to the one or more timelines associated with the foundational content (herein, also referred to as “content timelines”) that is to be enhanced by the effects. An effect timeline associated with an effect can be adapted relative to the multidimensional cue associated with the foundational content. In general, a cue associated with a timeline can indicate state or stop of a portion of content (e.g., music clip or video transition) in the foundational content, possibly with respect to a particular layer of the foundational content (e.g., audio layer or bottom-most video layer); can associate a timestamp on the timeline with specific metadata; or can serve as a trigger for an action performed by an applied theme and/or theme-based effect (e.g., trigger start or stop of a video overlay, trigger change in text overlay, or trigger change in soundtrack applied by the theme and/or theme-based effect). As described herein, a multidimensional cue can be an indicator that triggers an action, with respect to a target effect, based on one or more factors relating to the contextual factors of the foundational content.

In adapting an effect timeline of an effect, the multidimensional cue-based content editing engine 208 can adjust the effect timeline to align with one or more cues of a content timeline associated with the foundational content, including multidimensional cues. Consider, for instance, where an animation effect comprises a layer in which a visual object traverses across the layer between a start cue and a stop cue on an effect timeline associated with the animation effect. When this example animation effect is applied to a given portion of foundational content, the start and stop cues on the effect timeline can be adjusted according to (e.g., aligned with) cues on the content timeline associated with the given content portion. In doing so, an effect can be applied to the given portion of the foundational content while preserving the content timeline associated with the foundational content.

To illustrate, suppose that the foundational content a user intends to enhance through system of FIG. 2, with an effect, comprises a set of video clips relating to a personal event, such as a birthday party. Further suppose that the user intends to apply a birthday party-related theme to the foundational content (e.g., animation displaying flying confetti) and that the video clips included in the foundational content are sequence according to a set of cues multidimensional cues associated with a content timeline associated with the foundational content. When applying the birthday party-related theme to the foundational content, the application of theme-based effects applied by way of the birthday party-related theme can adapted according to the conditions-based actions of the multidimensional cues, which can consider contextual factors of the foundational content when triggering actions. Additionally, various implementation can further avoid adapting the content timeline of the foundational content (e.g., adjusting the duration of one or more video clips included in the foundational content, or adjusting the overall duration of the foundational content) according to (e.g.to align with) the effect timeline (e.g., the duration) of the animation of the birthday party-related theme. Rather, such implementations can adapt the effect timeline of the animation of the birthday party-related theme according to (e.g., to align with) the content timeline of the foundational content. In doing so, various implementations can apply the birthday party-related themes to foundational content without compressing, extending, or cutting short the duration of the foundational content or any portion of content included therein.

In adapting application the effect, a multidimensional cue can trigger the multidimensional cue-based content editing engine 208 to change the behavior/impact of an visual or audio effect currently being expressed over the foundational content (e.g., currently enabled), at a given time position on a timeline associated with the foundational content, based on one or more conditions relating to contextual factors of the foundational content. The change in behavior/impact can be facilitated by a change in an effect parameter of the visual or audio effect. Examples of actions triggered with respect to effects can include, without limitation, enabling or disabling expression of effects, initiating a transitional start or end of effects (e.g., fading-in start or fade-out end for an effect), implementing transitions between two or more effects, defining effect parameters, adapting effect parameters of effects, and the like. As noted herein, where a theme is applied to foundational content, a multidimensional cue can trigger actions with respect to one or more theme-based effects that convey the overall effect of the theme on the foundational content.

In certain implementations, once an effect is selected for application, the multidimensional cue-based content editing engine 208 can directly apply the selected effect to the foundational content, or employ the use of the multidimensional cue-based effects content rendering engine 214 to apply the selected effect to the foundational content. In some implementations where the multidimensional cue-based content editing engine 208 directly applies the selected effect to the foundational content, the multidimensional cue-based effects content rendering engine 214 can generate the rendered content product from the foundational content as provided by the multidimensional cue-based content editing engine 208. Alternatively, in various implementations where the multidimensional cue-based effects content rendering engine 214 can apply the selected effect to the foundational content on behalf of the multidimensional cue-based content editing engine 208 and then provide the foundational content that results to the multidimensional cue-based content editing engine 208.

To conserve on processing time, processing resources, bandwidth, and the like, the multidimensional cue-based content editing engine 208 in certain implementations may or may not utilize lower quality content (e.g., non-high definition video) or effects when creating content, and/or modifying content with respect to foundational content. The lower quality foundational content that results from use of such lower quality items can be useful for preview purposes, particularly when the foundational content is being actively edited. Eventually, the multidimensional cue-based effects content rendering engine 214 can generate a higher quality version of the foundational content (i.e., the rendered theme-based content product) when a user has concluded previewing and/or editing the foundational content.

For various implementations, once an initial effect is applied to the foundational content (to result in an initial resulting foundational content), an alternative effect can be applied in place of, or in addition to, the effect, thereby resulting in an alternative version of the resulting foundational content. Those skilled in the art will appreciate that once a given multidimensional cue is added in relation to a timeline associated with the foundational content, the given multidimensional cue can trigger an action with respect to effects already applied to the foundational content or effects applied to the foundational content after addition of the multidimensional cue.

In the example of FIG. 2, the effects library engine 210 can is coupled to the effects library datastore 212 and manages effects that can be applied to the foundational content. For some implementations, the effects library engine 210 can also manage themes and related theme-based effects stored in the effects library datastore 212. As discussed herein, a “theme” can comprise one or more layers of theme-based effects, which may be audio or visual in nature and facilitate the overall effect of the theme on the content being created or modified. Accordingly, for some implementations, the theme-based effects managed according to the themes to which they are associated, where a given theme-based effect may or may not be associated with more than one theme.

For some implementations, the effects library engine 210 can be responsible for adding, deleting and modifying effects, themes and/or the theme-based effects stored on the effects library datastore 212, for retrieving a listing of content items stored on the effects library datastore 212, for providing details regarding effects, themes and/or theme-based effects stored on the effects library datastore 212, and for providing to other engines effects, themes and/or theme-based effects from the library. For example, the effects library engine 210 can provide effects, themes and/or theme-based effects to the multidimensional cue-based content editing engine 208 as a user reviews or selects an effect and/or theme to be added to the foundational content that the user intends to enhance. In another example, the effects library engine 210 can provide effects and/or theme-based effects to the multidimensional cue-based effects content rendering engine 214 as the engine 214 renders one or more layers of the foundational content to generate a rendered theme-based content product (which may be ready for consumption by others).

In the example of FIG. 2, the effects library datastore 212 can store one or more effects. As discussed herein, effects can comprise an audio or visual effect configured to overlay the foundational content. For some implementations, the effect can comprise an audio or visual effect triggered according to at least one multidimensional cue associated with the content timeline. Depending on the implementation, the effect can comprise an animation layer, a static layer, a title, a transition, a lower third, a caption, a color correction layer, or a filter layer.

In some instances, the effect can comprise a piece of multimedia content (e.g., audio, video, or animation clip), which may or not be in a standard multimedia format. For example, an audio effect can be embodied in such audio file formats as WAV, AIFF, AU, PCM, MPEG (e.g., MP3), AAC, WMA, and the like. In another example, a video effect can be embodied in such video file formats as AVI, MOV, WMV, MPEG (e.g., MP4), OGG, and the like. In a further example, an image effect can be embodied in such image file formats as BMP, PNG, JPG, TIFF, and the like, or embodied in such vector-based file formats as Adobe® Flash, Adobe® Illustrator, and the like. Those skilled in the art will appreciate that other audio, video, or image effects can be embodied in other multimedia file formats that may or may not be applied to the foundational content as an overlay layer. When an effect is stored on the effects library datastore 212, effects can be stored in their native multimedia file formats or, alternatively, converted to another multimedia format (e.g., to an audio and/or video file format common across datastore 212). Depending on the implementation, the effects library datastore 212 can store an effect in association with a given theme by storing the association between the given theme and the effects stored.

In the example of FIG. 2, the multidimensional cue-based effects content rendering engine 214 can render one or more layers of the foundational content, using a selected effect provided by the effect library engine 210 (from the effects library datastore 212), after the selected effect is applied to the foundational content by the multidimensional cue-based content editing engine 208. As a result of rendering operation(s), the multidimensional cue-based effects content rendering engine 214 can generate a rendered content product that is consumable by other users (e.g., via a stand-alone media player).

For example, the multidimensional cue-based effects content rendering engine 214 can generate the rendered content product to be in a media data format (e.g., QuickTime® movie [MOV], Windows® Media Video [WMV], or Audio Video Interleaved [AVI])) compatible with a standards-based media players and/or compatible with a streaming media service (e.g., YouTube®). As the multidimensional cue-based effects content rendering engine 214 renders layers of the foundational content to generate the rendered content product, the multidimensional cue-based content editing engine 208 can provide the multidimensional cue-based effects content rendering engine 214 with information specifying the effect(s) presently applied to the foundational content, how one or more timelines associated with the effect have been adapted (so that the effect can be applied the foundational content during rendering while aspects of the associated content timeline are preserved), the desired quality (e.g., 480p, 780p, or 1080p video) or version for the resulting layers, and/or the desired media format of the rendered content product.

Once generated, the multidimensional cue-based effects content rendering engine 214 can provide the rendered content product that results to the content publication engine 216. In the example of FIG. 2, the content publication engine 216 can receive a rendered content product from the multidimensional cue-based effects content rendering engine 214 and publishes the rendered content product for consumption by the others. For example, the rendered content product can be published such that the rendered content product can be downloaded and saved by the user or others as a stand-alone content file (e.g., MPEG or AVI file), or such that rendered content product can be shared to other over the network (e.g., posted to a website, such as YouTube® so that others can play/view the rendered content product). Once published, the rendered content product can be stored on the server-version content datastore 218. For some implementations, the published rendered content product can be added to a content library datastore (not shown) for reuse in other content products. Depending on the implementation, the published rendered content product can be added to a content library datastore as for-purchase content (for instance, via a content library/market place engine, with the sales proceeds being split between amongst the user and the content editor service provider), or added to the content library datastore as free content available to the public. The user can also define content usage parameters (i.e., licensing rights) for their rendered content product when the rendered content product is added to a content library datastore.

In the example of FIG. 2, the content editor client 206 can comprise the content editor user interface engine 222 and a local-version content datastore 224 coupled to the content editor user interface engine 222. The content editor user interface engine 222 can facilitate multidimensional cue-based effect application, content creation, or content modification of foundational content at the multidimensional cue-based content editor server 202 by the content editor client 206. As noted herein, the content editor user interface engine 222 can establish a connection with the multidimensional cue-based content editing engine 208 through the computer-readable medium 204, and then issue theme application, content creation, or content modification commands to the multidimensional cue-based content editing engine 208. In accordance with the issued commands, the multidimensional cue-based content editing engine 208 can perform the multidimensional cue-based effect application, content creation, or content modification operations at the multidimensional cue-based content editing engine 208, and can return to the content editor user interface engine 222 a version of the resulting foundational content.

Alternatively, the content editor client 206 can apply an effect in accordance with a multidimensional cue and modify content by receiving a copy of the latest version of the foundational content as stored at the multidimensional cue-based content editor server 202, applying the effect to or modifying the received copy, and then uploading the effect-applied/modified copy to the multidimensional cue-based content editor server 202 so that the effect application and/or modifications can be applied to the last version of the foundational content stored at the multidimensional cue-based content editor server 202. When the effect-applied/modified copy is uploaded from the content editor client 206 to the multidimensional cue-based content editor server 202 to facilitate multidimensional cue-based effect application and/or content modification of the foundational content, various implementations can utilize one or more methods for optimizing the network bandwidth usage.

In some embodiments, where the multidimensional cue-based content editor server 202 is implemented using virtual or cloud-based computing resources, such virtual or cloud-based computer resources can be managed through the cloud management engine 220. The cloud management engine 220 can delegate various content-related operations and sub-operations of the server 202 to virtual or cloud-based computer resources, and manage the execution of the operations. Depending on the embodiment, the cloud management engine 220 can facilitate management of the virtual or cloud-based computer resources through an application program interface (API) that provides management access and control to the virtual or cloud-based infrastructure providing the computing resources for the multidimensional cue-based content editor server 202.

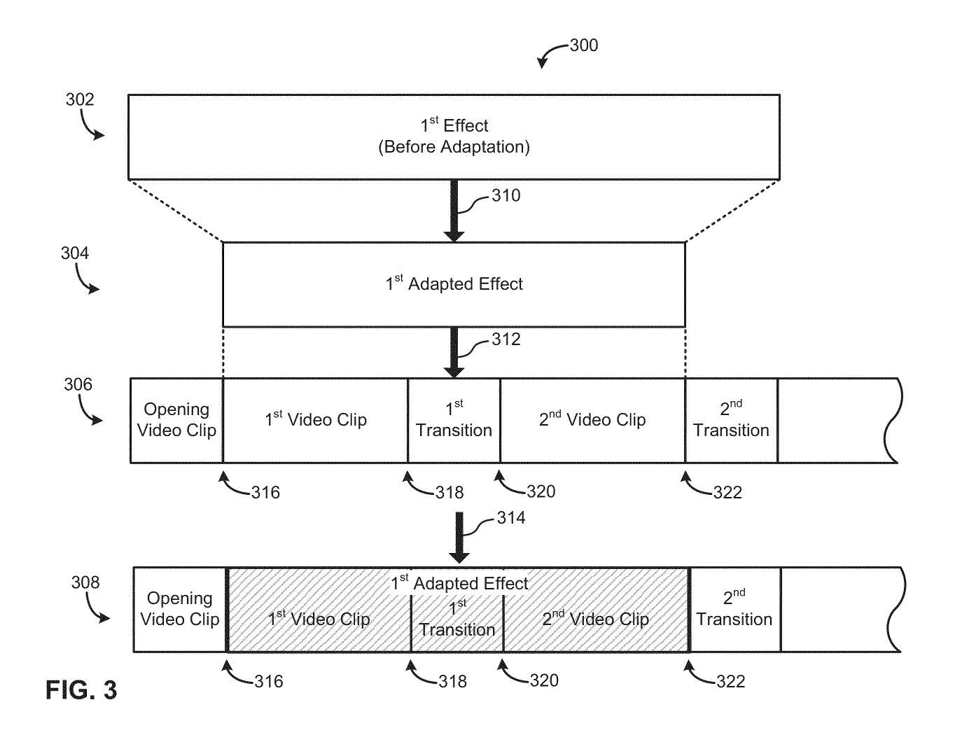

FIG. 3 depicts a diagram 300 illustrating an example adaptation of an effect timeline in accordance with some implementations. In particular, the example of FIG. 3 illustrates adaptation of an effect timeline 302, associated with a first effect, before the first effect is applied to a foundational content, represented by a content timeline 306. According to the content timeline 306 as shown, the foundational content can comprise an opening video clip at the start, a 1^{st} video clip between cues 316 and 318, a first transition (e.g., video or audio transition) between cues 318 and 320, a second video clip between cues 320 and 322, a second transition, and possibly additional content portions. As also shown, during application of the first effect to the foundational content, the effect timeline 302 associated with the 1^{st} effect can be adapted (310) to an adapted effect timeline 304 and then applied (312) to the foundational content associated with the content timeline 306. In accordance with some implementations, one or more of the cues 316, 318, 320, and 322 can be multidimensional cues configured to trigger an action with respect to the 1^{st} adapted effect applied to the foundational content.

Depending on the implementation, adaptation of the effect timeline 302 can include shortening or lengthening the overall duration of the effect timeline 302. For some implementations, the shortening of the duration of the effect timeline 302 can involve the compression one or more portions of the effect timeline 302 and/or removal of one or more portions of the effect timeline 302. Consequently, the adaptation of the effect timeline 302 to the adapted effect timeline 304 can determine the impact of the effect on the foundational content, such as what effects are presented in the foundational content, how long effects of the effect are presented in the foundational content, or how the effects are presented in the foundational content (e.g., speed of animation effect applied through the theme and/or the effect). Once the first effect is applied to the foundational content, the resulting foundational content may or may not be similar to that of content timeline 308.

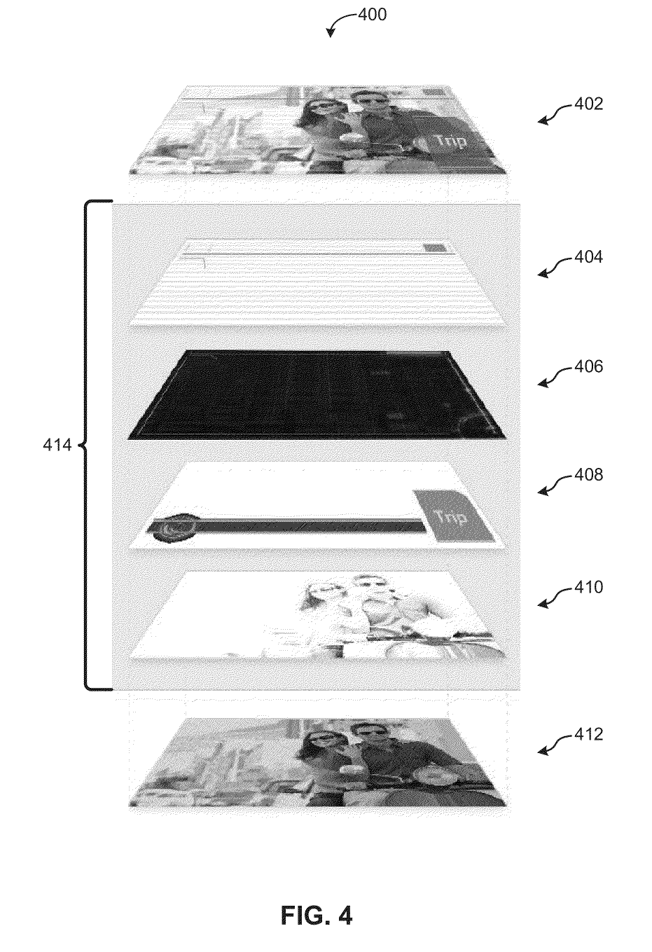

FIG. 4 depicts a diagram 400 illustrating an example structure of a theme-based foundational content 402 in accordance with some implementations. As noted herein, a “theme” can comprise one or more layers of theme-based effects, which may be audio or visual in nature and facilitate the overall effect of the theme on the content being created or modified. Accordingly, for some implementations, the theme-based effects can be applied according to multidimensional cue. In the example of FIG. 4, the theme-based foundational content 402 can result from applying a theme 414 to a foundational content 412. As described herein, the theme 414 can be applied to a foundational content by overlaying theme-based effects included therein over the foundational content 412. As shown, the theme 414 can comprise an image adjustment layer 410, a general layer 408 disposed over the image adjustment layer 410, an animation layer 406 disposed over the general layer 408, and a static layer 404 disposed over the animation layer 406. As noted herein, themes can comprise one or more theme-based effects, and such theme-based effects can be applied to foundational content by way of one or more layers. Accordingly, in some implementations, the image adjustment layer 410 can include color corrections, filters, and the like. The general layer 408 can include titles, transitions (e.g., audio or video), lower thirds, captions, and the like. The animation layer 406 can include vector-based animations and the like. The static layer 404 can include static images/graphics and the like.

Those skilled in the art will appreciate that the structure of themes and/or theme-based effects applied to foundational content can differ between implementations. Those skilled in the art will also appreciate that the theme-based effects 404, 406, 408, and 410 described with respect to FIG. 4 can be applied to foundational content as effects independent of the theme. In accordance with some implementations, the behavior/impact of one or more of the theme-based effects 404, 406, 408, and 410 described can be influenced by the one or more multidimensional cues associated with a timeline relating to the foundational content 402.

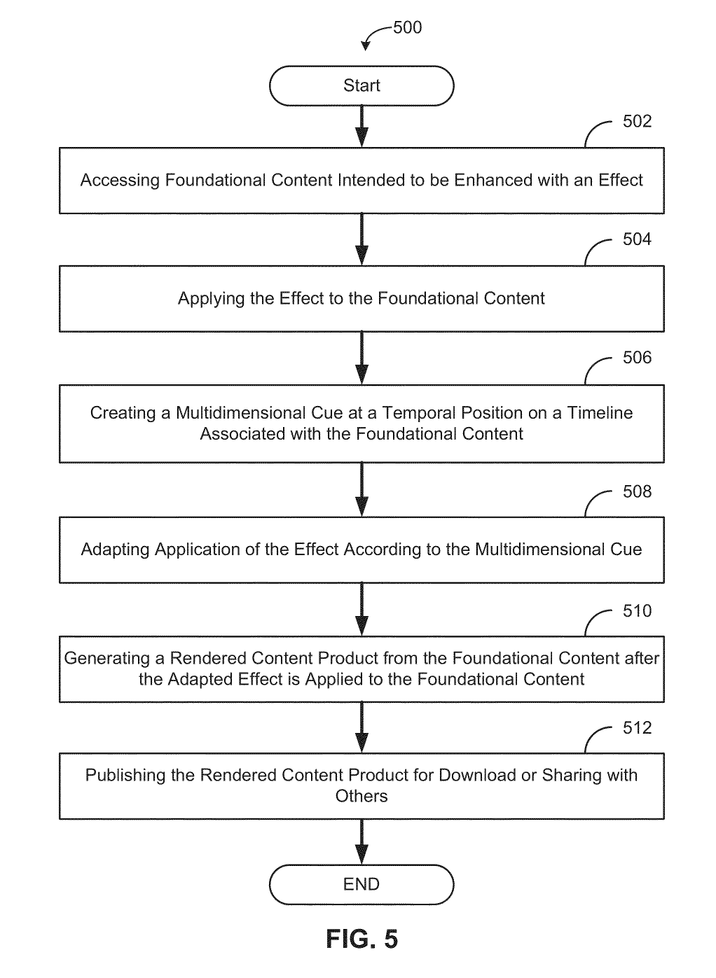

FIG. 5 depicts a flowchart 500 of an example of a method for multidimensional cue-based content editing in accordance with some implementations. Those skilled in the art will appreciate that in some implementations, the modules of the flowchart 500, and other flowcharts described in this paper, can be reordered to a permutation of the illustrated order of modules or reorganized for parallel execution. In the example of FIG. 5, the flowchart 500 can start at module 502 with accessing foundational content intended to be enhanced by a video or audio effect. As described herein, the foundational content can be that which a user intends to apply a selected effect associated therewith. For example, the foundational content can be provided by a user or by a third-party (e.g., vendor), who may or may not provide it for a cost. As also described herein, the foundational content can be associated with a content timeline, which can comprise information defining a layer of the foundational content, defining content within the layer, or defining a temporal property of content within the layer.

In the example of FIG. 5, the flowchart 500 can continue to module 504 with applying the effect to the foundational content. For some implementations, the effect can be applied in response to a request to apply the effect to the foundational content. When applying the effect to the foundational content, various implementation can receive the effect to be applied the foundational content. The effect can have an associated effect timeline, which may or may not comprise information defining a layer of the effect, defining one or more audio or visual effects within the layer, or defining a temporal property of the audio or visual effects within the layer.

Subsequently, the flowchart 500 can continue to module 506 with creating a multidimensional cue at a temporal position on a timeline associated with the foundational content. According to various implementations, the multidimensional cue can be configured to trigger an action with respect to the effect, at a temporal position on the timeline when a first condition that relates to contextual information of the foundational content is satisfied. At or after creation of the multidimensional cue, the user requesting application of the effect can enter specifics that define some or all aspects of the multidimensional cue, and define how the multidimensional cue adapts application of the effect according to contextual information from the foundational content. For example, a use may define one or more parameters of the multidimensional cue that can determine what actions are trigged by the multidimensional cue, conditions considered by the multidimensional cue for triggering actions, or contextual factors of the foundational considered by the multidimensional cue.

Thereafter, the flowchart 500 can continue to module 508 with adapting application of the effect according to the multidimensional cue associated with a timeline associated with the foundational content. As described herein, applying the effect can comprise adapting the associated effect timeline according to one or more multidimensional cues while preserving the associated content timeline.

The flowchart 500 can continue to module 510 with generating a rendered content product from the foundational content after the effect is adapted to the foundational content. As described herein, the rendered content product is consumable by another user (e.g., via a stand-alone media player). Further, the flowchart 500 can continue to module 512 with publishing the rendered content product for download or sharing with others. For some implementations, the publication of the rendered content product can enable the rendered content product to be consumable by another user.

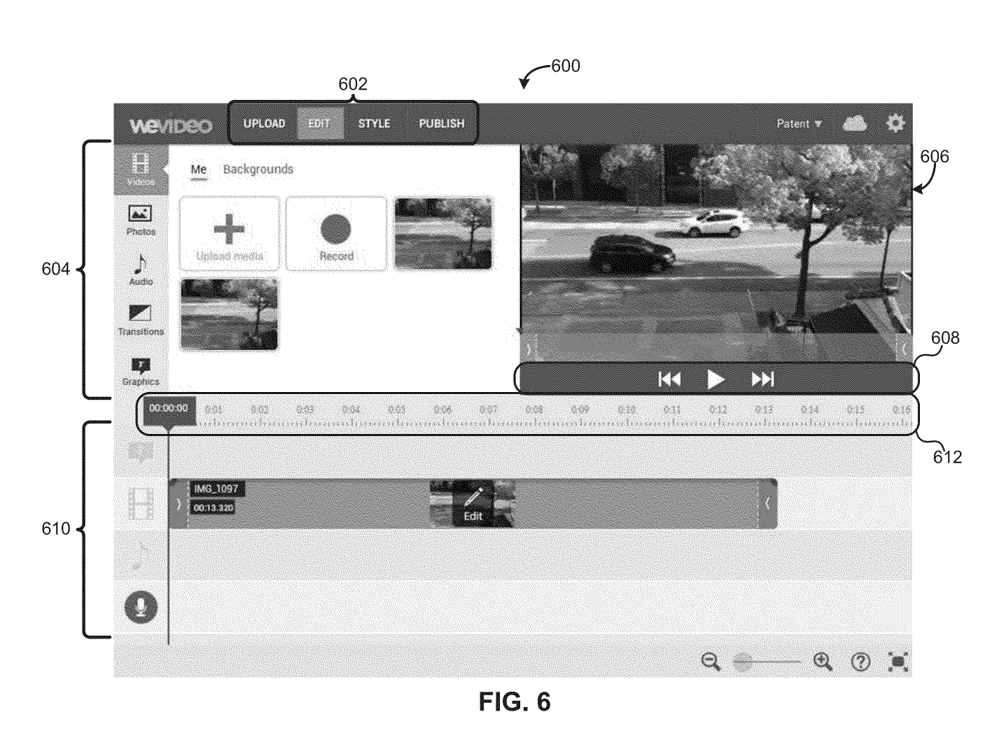

FIG. 6 depicts a diagram of an example of a client-side user interface 600 for multidimensional cue-based content editing in accordance with some implementations. With respect to some implementations, the client-side user interface of FIG. 6 can control effect application, creation or modification of multidimensional cues in association with effects, content creation, or content editing operations performed on foundational content. In particular, the client-side user interface 600 can control a multidimensional cue-based content editing engine operating at a client, an effects content editing engine operating at a server, or both to facilitate the effect application, creation or modification of multidimensional cues in association with effects, content creation and content editing operations on the foundational content. For some implementations

As described herein, for various implementations, the client-side user interface 600 can cause various engines to operate such that foundational content is enhanced by the server using an effect in accordance with a multidimensional cue and the resulting foundational content is received by a client from the server. The client-side user interface 600 can also cause engines to operate such that a copy of the foundational content is enhanced or modified at the client using effects (e.g., a preview version is enhanced or modified at the client), and an enhanced/modified foundational content is uploaded to the server (e.g., for updating the latest version of the foundational content and/or final rendering of the foundational content into a rendered content product).

Additionally or alternatively, the client-side user interface 600 can cause various engines to operate such that the foundational content is prepared and stored at a server on behalf of the client, the client instructs the server to perform multidimensional cue-based content editing operations on the foundational content, and the client instructs the server (e.g., through the client-side user interface 600) to accordingly edit the latest version of the foundational content at the server. The behavior and/or results of the client-side user interface 600 based on user input can be based on individual user preferences, administrative preferences, predetermined settings, or some combination thereof.

In some implementations, the client-side user interface 600 can be transferred from a server to a client as a module that can then be operated on the client. For instance, the client-side user interface 600 can comprise a client-side applet or script that is downloaded to the client from the server and then operated at the client (e.g., through a web browser). Additionally, the client-side user interface 600 can operate through a plug-in that is installed in a web browser. User input to the client-side user interface 600 can cause a command relating to online content editing, such as a content layer edit command or a content player/viewer command, to be performed at the client or to be transmitted from the client to the server.

The client-side user interface 600 can include multiple controls and other features that enable a user at a client to control the application of effects, the creation or modification of a multidimensional cue on a timeline associated with the foundational content, content creation with respect to the foundational content, and content modification of foundational content. In the example of FIG. 6, the client-side user interface 600 includes a tabbed menu bar 602, a content listing 604, a content player/viewer 606, content player/viewer controls 608, a content layering interface 610, and a content timeline indicator 612.

As shown, the client-side user interface 600 can include the tabbed menu bar 602 that allows the user to select between: loading foundational content to a multidimensional cue-based content editing system (for effects-based enhancement, content creation, or content modification using multidimensional cues); adding, removing, or modifying multidimensional cues with respect to timelines associated with the foundational content (including timelines associated with effects applied to the foundational content); previewing and/or adding different content types (e.g., video, audio, or images/graphics available to them from a content library) to the foundational content, switching to content-creation/content-editing operations that can be performed on the foundational content; previewing and/or applying an effect to the foundational content, where a multidimensional cue possibly adapts the application of the effect.

In the example of FIG. 6, the tabbed menu bar 602 presents a user with selecting between “Upload” (e.g., uploading personal content or themes), “Edit” (e.g., content editing mode, which presents the client-side user interface 600 as shown in FIG. 6), “Style” (e.g., applying styles to the foundational content through use of one or more themes), and “Publish” (e.g., publishing the latest version of the foundational content for consumption by others). The personal content can be that which the user uploaded to their account on the server, that which the user already created on the server, or both. Those of ordinary skill in the art would appreciate that in some embodiments, the tabbed menu bar 602 can include one or more selections that correspond to other functionalities of a multidimensional cue-based content editing system.

In the example of FIG. 6, the content listing 604 can display a list of content available (e.g., from a content library) for use when editing the foundational. From the content listing 604, a user can add content to a new or existing content layer of the foundational content, possibly by “dragging-and-dropping” content items from the content listing 604 into the content layering interface 610. Examples of content types that can be the content listing 604 video, audio, images/graphics, transitions (e.g., audio or video), and the like. Depending on the implementation, transitions can include predefined (e.g., vendor provided) or user-created content transitions that can be inserted between two content items in a layer of the foundational content. For instance, with respect to video content (i.e., video clips), available transitions can include a left-to-right video transition which once inserted between a first video clip and a second video clip, can cause the first video clip transition to the second video clip in a left-to-right manner. Similarly, with respect to audio content (i.e., audio clips), available transitions can include a right-to-left transition which once inserted between a first audio clip and a second audio clip, can cause the first audio clip to fade into to the second audio clip starting from the right audio channel and ending at the left audio channel. As described herein, in some implementations, transitions can be start or stop according to one or more cues or multidimensional cues that are associated with a timeline of the foundational content or an effect applied to the foundational content.

In some implementations, the content listing 604 can list the available content with a thumbnail image configured to provide the user with a preview of the content. For example, for a video content item, the thumbnail image may be a moving image that provides a brief preview of the video content item before it is added to the foundational content. With respect to an image content item, the thumbnail preview may be a smaller-sized version (i.e., lower resolution version) of the image content item. In certain implementations, a content item listed in content listing 606 can be further previewed in the content player/viewer 606, which may or may not be configured to play audio, play video, play animations, and/or display images (e.g., in a larger resolution than the thumbnail preview). The content listing 604 can also provide details regarding the listed content where applicable, including, for example, a source of the content, a date of creation for the content, a data size of the content, a time duration of the content, licensing information relating to the content item (where, and cost of using the content item.

In certain implementations, the user can graphically modify a temporal position or duration of a content layer or a content item within a content layer of the foundational content. Further, various implementations can permit a user to graphically add, remove, or modify a multidimensional cue in association with a timeline of the foundational content. For instance, the user can “drag-and-drop” the graphical representation of a multidimensional cue to indicate the start or end of a content item, to adjust the duration of the content item (thereby the temporal start of temporal end of the content item), or adjust when a multidimensional cue should consider the contextual factors of the foundational content to perform an action with respect to an effect applied to the foundational content. In another example, a user can use a “drag-and-drop” action or other GUI-based action to associate actions of a given multidimensional cue with one or more effects applied to the foundational content. For some embodiments, when a temporal position, duration, or other temporal characteristic, associated with a content layer or a content item of the foundational item, is adjusted by way of a multidimensional cue or other type of cue, corresponding adjustments can be automatically performed to any effect that is presently applied to the foundational content. In this way, for some implementations, content modification can be performed on the foundational content even after an effect has been applied, while the impact of the effect is maintained.

In the example of FIG. 6, a user can utilize the player/viewer 606 to preview content items (e.g., videos, photos, audio, transitions, or graphics) listed in the content listing 604 and available for use when creating or modifying content in the foundational content. The content player/viewer 606 can also provide a preview of the foundational content that is being enhanced, created or modified through the client-side user interface 600. Depending on the implementation, the version of the foundational content that can be previewed through the client-side user interface 600 can be the latest version stored at the server, at the client, or both.

In one example, the user can applying an effect to the foundational content that the user intends to enhance then preview the resulting foundational content through the content player/viewer 606. Depending on the embodiment, the content being previewed can be from a latest version of the foundational content residing at the server, a rendered version of the foundational content residing at the server, or a latest version of foundational content locally residing at the client. Where content being played or shown is provided from the server, such content can be streamed from the server to the client as the content is played or shown through the content player/viewer 606. In some embodiments, where content being played or shown is provided from the server, such content can be first downloaded to the client before it is played or shown through the content player/viewer 606.

In the example of FIG. 6, a user can control the operations of the content player/viewer 606 using the content player/viewer controls 608. The content player/viewer controls 608 can include control commands common to various players, such as previous track, next track, fast-backward, fast-forward, play, pause, and stop. In some implementations, a user input to the content player/viewer controls 608 can result in a content player/viewer command instruction being transmitted from the client to the server, and the server providing and/or streaming the content to the client to facilitate playback/viewing of selected content.

In the example of FIG. 6, the content layering interface 610 can enable a user to access and modify content layers of the foundational content. The content layering interface 610 can comprise a stack of content layer slots, where each content layer slot can graphically present all the content layers of a particular content type associated to the collaborative content product, or can present each content layer is a separate slot. Example content types include, without limitation, graphical content (e.g., “Graphics”), video content (e.g., “Video”), image content (e.g., “Image”), and audio content (e.g., “Audio”). Additionally, for particular implementations, when an effect is applied to the foundational content, the applied effect can be graphically presented in a separate layer slot in the content layering interface 610. The content layering interface 610 as shown in FIG. 6 comprises a content layer slot for graphical content, video content, soundtrack content, and audio recording content. Depending on the implementation, a given multidimensional cue can be graphically represented in the content layering interface 610 in association with those layers in which the given multidimensional cue triggers an action with respect to an effect. For example, where a given multidimensional cue triggers an action in regard to an effect that influences both video and audio, the given multidimensional cue can be represented as a graphical marker in the video content layer slot and another graphical marker in the soundtrack content layer slot.

The content layering interface 610 can also comprise controls or features that enable the user to edit content layers of the foundational content. Through the content layering interface 610, a user can implement edits to a content layers, or content items thereof, particularly with respect to timelines and/or temporal elements (e.g., cues or multidimensional cues) associated with the content layer or content item (e.g., temporal position or duration of a content item). In some embodiments, the content layering interface 610 can display timelines and/or temporal elements relating to an effect once it has been applied to the foundational content. Temporal elements, such as content starts, stops, multidimensional cues and the like, can be graphically represented in content layers as time markers. In some instances, a time marker for a given multidimensional cue can be shown according to what the cue represents (e.g., temporal start, stop, or pause), the time value the cue represents, the timeline associated with the cue, or the effect to which the cue is associated. Positioning of the time marker in the content layering interface 610 can be relative the content timeline indicator 612. For some implementations, adjustments to multidimensional cues can be facilitated (by a user) through use of time markers in the content layering interface 610 (e.g., “drag-and-drop” actions in connection with the time markers). The content layering interface 610 can include edit controls that enable a user to add, delete or modify one or more content layers of the foundational content. Example edit controls include adding a content layer, deleting a content layer, splitting a single content layer into two or more content layers, editing properties of a content layer, and the like.

In the example of FIG. 6, the content timeline indicator 612 can visually assist a user in determining a temporal position of a content layer or content item, or multidimensional cue in the foundational content. For instance, the content timeline indicator 612 can comprise a time marker representing a multidimensional cue, such as a temporal start point or a temporal end point for a content layer or a content item in the content layer. In certain implementations, the length of the content timeline indicator 612 can adapt according to the overall duration of the collaboratively-created creation, or can be adjusted according to a user-setting.

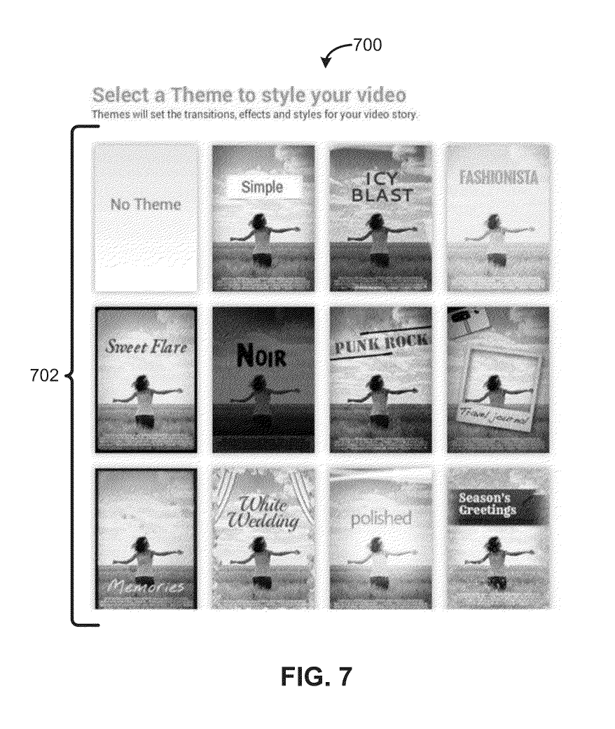

FIG. 7 depicts a diagram 700 of an example of an interface for selecting a theme for application in accordance with some implementations. As noted herein, in some implementations, an effect applied to foundational content can be part of a theme comprising one or more effects (also referred to as “theme-based effects”) that apply aspects of the theme to the foundational content. In the example of FIG. 7, the interface presents a selection of themes that can be applied to a foundational content including, for example, a simple theme, an “icy blast” theme, a fashionista theme, a “sweet flare” theme, a noir theme, a punk rock theme, a travel journal theme, a memories theme, a white wedding theme, a polished theme, and a season's greetings theme.

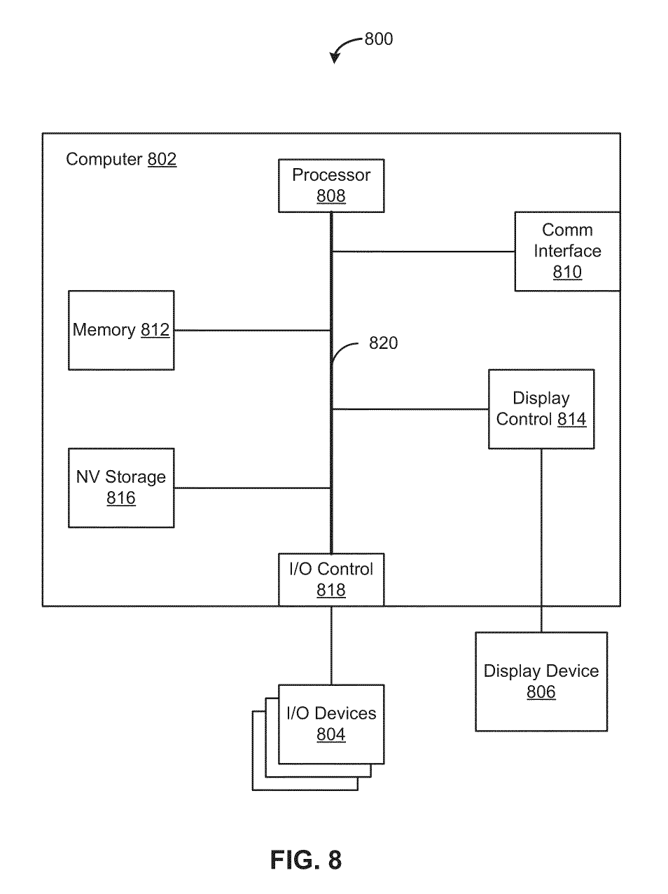

FIG. 8 depicts a diagram of an example of a system on which techniques described in this paper can be implemented. The computer system 800 can be a conventional computer system that can be used as a client computer system, such as a wireless client or a workstation, or a server computer system. The computer system 800 includes a computer 802, I/O devices 804, and a display device 806. The computer 802 includes a processor 808, a communications interface 810, memory 812, display controller 814, non-volatile storage 816, and I/O controller 818. The computer 802 may be coupled to or include the I/O devices 804 and display device 806.

The computer 802 interfaces to external systems through the communications interface 810, which may include a modem or network interface. It will be appreciated that the communications interface 810 can be considered to be part of the computer system 800 or a part of the computer 802. The communications interface 810 can be an analog modem, ISDN modem, cable modem, token ring interface, satellite transmission interface (e.g. “direct PC”), or other interfaces for coupling a computer system to other computer systems.

The processor 808 may be, for example, a conventional microprocessor such as an Intel Pentium microprocessor or Motorola power PC microprocessor. The memory 812 is coupled to the processor 808 by a bus 820. The memory 812 can be Dynamic Random Access Memory (DRAM) and can also include Static RAM (SRAM). The bus 820 couples the processor 808 to the memory 812, also to the non-volatile storage 816, to the display controller 814, and to the I/O controller 818.

The I/O devices 804 can include a keyboard, disk drives, printers, a scanner, and other input and output devices, including a mouse or other pointing device. The display controller 814 may control in the conventional manner a display on the display device 806, which can be, for example, a cathode ray tube (CRT) or liquid crystal display (LCD). The display controller 814 and the I/O controller 818 can be implemented with conventional well known technology.

The non-volatile storage 816 is often a magnetic hard disk, an optical disk, or another form of storage for large amounts of data. Some of this data is often written, by a direct memory access process, into memory 812 during execution of software in the computer 802. One of skill in the art will immediately recognize that the terms “machine-readable medium” or “computer-readable medium” includes any type of storage device that is accessible by the processor 808 and also encompasses a carrier wave that encodes a data signal.

The computer system 800 is one example of many possible computer systems which have different architectures. For example, personal computers based on an Intel microprocessor often have multiple buses, one of which can be an I/O bus for the peripherals and one that directly connects the processor 808 and the memory 812 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 812 for execution by the processor 808. A Web TV system, which is known in the art, is also considered to be a computer system, but it may lack some of the features shown in FIG. 8, such as certain input or output devices. A typical computer system will usually include at least a processor, memory, and a bus coupling the memory to the processor.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm in here is conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As disclosed in this paper, implementations allow editors to create professional productions using effects, themes, and multidimensional cues, and possibly based on a wide variety of amateur and professional content gathered from numerous sources. Although the foregoing implementations have been described in some detail for purposes of clarity of understanding, implementations are not necessarily limited to the details provided.

We claim:

1. A system, comprising:
a multidimensional cue-based content editing engine;
an effects library engine coupled to the multidimensional cue-based content editing engine;
an effects library datastore coupled to the effects library engine, wherein the effects library datastore comprises an effect;
wherein, in operation:
the multidimensional cue-based content editing engine accesses foundational content that a user intends to enhance with the effect, wherein the foundational content is associated with a timeline that defines a temporal property with respect to the foundational content;
the effects library engine provides the effect to the multidimensional cue-based content editing engine from the effects library datastore;
the multidimensional cue-based content editing engine applies the effect to the foundational content;
the multidimensional cue-based content editing engine adapts application of the effect according to a multidimensional cue, wherein the multidimensional cue is configured to trigger an action with respect to the effect, at a temporal position on the timeline when a first condition that relates to contextual information of the foundational content is satisfied.

2. The system of claim 1, wherein, in operation, the multidimensional cue-based content editing engine creates the multidimensional cue.

3. The system of claim 1, wherein the action includes enabling or disabling the expression of the effect.

4. The system of claim 1, wherein the action includes adjusting a parameter of the effect, and the parameter determines how the effect is expressed with respect to the foundational content.

5. The system of claim 4, wherein the parameter defines how expression of the effect begins or ends.

6. The system of claim 4, wherein the parameter defines a position of the effect.

7. The system of claim 4, wherein the parameter defines a movement of the effect.

8. The system of claim 1, wherein the contextual information includes an audio attribute of the foundational content.

9. The system of claim 1, wherein, in operation:
the effects library engine provides another effect to the multidimensional cue-based content editing engine from the effects library datastore;
the multidimensional cue-based content editing engine applies another effect to the foundational content, wherein the contextual information includes an audio attribute of the foundational content as modified by the other effect.

10. The system of claim 1, wherein the contextual information includes a visual attribute of the foundational content.

11. The system of claim 1, wherein, in operation:
the effects library engine provides another effect to the multidimensional cue-based content editing engine from the effects library datastore;
the multidimensional cue-based content editing engine applies another effect to the foundational content, wherein the contextual information includes a visual attribute of the foundational content as modified by the other effect.

12. The system of claim 1, wherein the multidimensional cue triggers the action with respect to the effect when the first condition is satisfied and when a second condition relating to a defined temporal position on the timeline is satisfied.

13. The system of claim 1, further comprising:
generating from the foundational content a rendered content product after at least after application of the effect is adapted, wherein the rendered content product is consumable by another user;
publishing the rendered theme-based content product for consumption by another user.

14. The system of claim 1, wherein the effect is applied to the foundational as part of a theme applied to the foundational content.

15. A method, comprising:
accessing, at a computer system, foundational content to which a user intends to apply an effect, wherein the foundational content is associated with a timeline that defines a temporal property with respect to the foundational content;
applying the effect to the foundational content;
adapting application of the effect according to a multidimensional cue, wherein the multidimensional cue is configured to trigger an action with respect to the effect, at a temporal position on the timeline when a first condition that relates to contextual information of the foundational content is satisfied.

16. The method of claim 15, further comprising creating the multidimensional cue.

17. The method of claim 15, wherein the action includes enabling or disabling the expression of the effect.

18. The method of claim 15, wherein the action includes adjusting a parameter of the effect, and the parameter determines how the effect is expressed with respect to the foundational content.

19. The method of claim 18, wherein the parameter defines how expression of the effect begins or ends.

20. The method of claim 18, wherein the parameter defines a position of the effect.

21. The method of claim 18, wherein the parameter defines a movement of the effect.

22. The method of claim 15, wherein the contextual information includes an audio attribute of the foundational content.

23. The method of claim 15, further comprising applying another effect to the foundational content, wherein the contextual information includes an audio attribute of the foundational content as modified by the other effect.

24. The method of claim 15, wherein the contextual information includes a visual attribute of the foundational content.

25. The method of claim 15, further comprising applying another effect to the foundational content, wherein the contextual information includes a visual attribute of the foundational content as modified by the other effect.

26. The method of claim 15, wherein the multidimensional cue triggers the action with respect to the effect when the first condition is satisfied and when a second condition relating to a defined temporal position on the timeline is satisfied.

27. The method of claim 15, further comprising:
generating from the foundational content a rendered content product after at least after application of the effect is adapted, wherein the rendered content product is consumable by another user;
publishing the rendered theme-based content product for consumption by another user.

28. The method of claim 15, wherein the effect is applied to the foundational as part of a theme applied to the foundational content.

29. A system, comprising:
a means for accessing, at a computer system, foundational content to which a user intends to apply an effect, wherein the foundational content is associated with a timeline that defines a temporal property with respect to the foundational content;
a means for applying the effect to the foundational content;
a means for creating a multidimensional cue configured to trigger an action with respect to the effect, at a temporal position on the timeline when a first condition that relates to contextual information of the foundational content is satisfied;
a means for adapting application of the effect according to the multidimensional cue.
